(19) United States
(12) Patent Application Publication
(10) Pub. No.: US 2017/0108580 A1
(43) Pub. Date: Apr. 20, 2017

(54) ELECTRONIC BUOY RADAR CHART DISPLAY SYSTEM AND METHOD OF SAME

(71) Applicant: Chien-Erh Weng, Kaohsiung City (TW)

(72) Inventors: Chien-Erh Weng, Kaohsiung City (TW); Yu-Chen Siao, Kaohsiung City (TW); Yang Lie, Kaohsiung City (TW)

(21) Appl. No.: 14/884,322

(22) Filed: Oct. 15, 2015

(51) Int. Cl. G01S 7/22; G06F 3/14; G01S 7/00; G01S 7/10; G01S 19/13

(52) U.S. Cl. CPC G01S 7/22; G01S 7/10; G01S 19/13; G01S 7/003; G06F 3/14

(57) ABSTRACT

An electronic buoy radar chart display system is applicable to a ship, and includes: an electronic buoy apparatus, configured to generate electronic buoy positioning data according to a position where an electronic buoy locates, and transmit the electronic buoy positioning data to a buoy transceiver; a satellite positioning module, configured to generate ship positioning data corresponding to the ship position; a processing module, connected to the buoy transceiver and the satellite positioning module, and configured to receive the electronic buoy positioning data and the ship positioning data, and calculate relative position data according to the electronic buoy positioning data and the ship positioning data; and a radar chart display apparatus, configured to display the electronic buoy positioning data, the ship positioning data, and the relative position data.

### BACKGROUND

Technical Field

The present invention relates to an electronic buoy radar chart display system and a method of same, and in particular, to an electronic buoy radar chart display system and a method of same used for displaying relative position information of an electronic buoy and a ship.

Related Art

Electronic buoy technologies have been widely applied in ships for fishing works, and currently, the conventional technologies include a patent application No. CN202230204 entitled “AIS and GPS Navigation Integrated Apparatus”, filed on May 23, 2012 with the State Intellectual Property Bureau of PRC, which discloses a technique for real-time displaying an AIS target in an electronic chart, and a patent application No. CN202035146 entitled “Handheld AIS Terminal”, filed on Nov. 9, 2011 with the State Intellectual Property Bureau of PRC, which discloses a technique for acquiring ship sailing information in real time by using a terminal device such as a notebook computer, a PDA and a smart phone in combination with an electronic chart.

As analyzed above, although the electronic buoy technologies have been widely applied in ships for fishing works, there is still no graphic information display interface developed by using a ship positioning point and electronic buoy relative position information. Conventional electronic buoy position information still needs another related navigation device of the ship, for example, an electronic chart system and an Automatic Identification System (AIS), to serve as a platform for position information displaying. By citing the prior art CN202035146 as an example, information is displayed by using a handheld mobile apparatus cooperated with a terminal device such as a notebook computer, a PDA and a smart phone together with an electronic chart. In the prior art, AIS messages of surrounding base stations, other ships or aircrafts are captured to assist piloting of a ship to avoid collision. In the prior art CN 202230204, an AIS device is connected to a GPS device, so that the two can be integrated into a system platform, and AIS information can be displayed in time in an electronic chart.

The two prior arts still need an electronic chart or an AIS platform to run a system, and both mainly display related information of other ships but cannot display relative position information of a ship positioning point and an electronic buoy.

### SUMMARY

The present invention provides an electronic buoy radar chart display system, applicable to a ship, in which by receiving a signal generated by an electronic buoy disposed at a fishing net or a fishing site of fishes and a signal of a ship local position positioned by a satellite positioning module, a relative position thereof is calculated by using a processing module, and the relative position is finally transmitted to a radar chart display apparatus; therefore, the relative position of buoy position data and ship positioning data is calculated, and the buoy position data and the ship positioning data are displayed by using a wearable augmented reality apparatus, a smart mobile apparatus, a computer and the like, thereby assisting an offshore fishing ship to establish a display interface system dedicated for an electronic buoy thereof, so as to achieve the objectives of reducing system operation processes and effectively reducing device construction cost.

The electronic buoy radar chart display system of the present invention is applicable to a ship, and includes: an electronic buoy apparatus, configured to generate electronic buoy positioning data according to a position where an electronic buoy locates, and transmit the electronic buoy positioning data to a buoy transceiver; a satellite positioning module, configured to generate ship positioning data corresponding to the ship position; a processing module, connected to the buoy transceiver and the satellite positioning module, and configured to receive the electronic buoy positioning data and the ship positioning data, and calculate relative position data according to the electronic buoy positioning data and the ship positioning data; and a radar chart display apparatus, configured to display the electronic buoy positioning data, the ship positioning data, and the relative position data.

The radar chart display method of the present invention uses a ship as a center, so that a relative position and a near-and-far relationship of an electronic buoy can be determined correctly, thereby enabling more efficient fishing works and further reducing fuel consumption cost wasted by invalid sailing.

In the present invention, a processing module is used to capture buoy position information and convert an information format, and then calculate a relative position of an electronic buoy and a ship positioning point together with a ship position positioning GPS module; therefore, it is most advantageous in that, devices such as an electronic chart and an AIS platform are no longer used, and related information can be displayed on a display interface apparatus merely by using a developed radar chart display interface program module together with a smart mobile apparatus, a wearable augmented reality apparatus, or a computer.

### BRIEF DESCRIPTION OF THE DRAWINGS

The disclosure will become more fully understood from the detailed description given herein below for illustration only, and thus are not limitative of the disclosure, and wherein:

FIG. 1 is a schematic block diagram of an electronic buoy radar chart display system according to an embodiment of the present invention;

FIG. 2 is a flow chart of steps of an electronic buoy radar chart display method according to an embodiment of the present invention; and

FIG. 3 is a schematic diagram of a radar chart operation interface according to an embodiment of the present invention.

### DETAILED DESCRIPTION

In order to make the above features and advantages of the present invention more comprehensible, embodiments are described in detail in the following through the accompanying drawings.

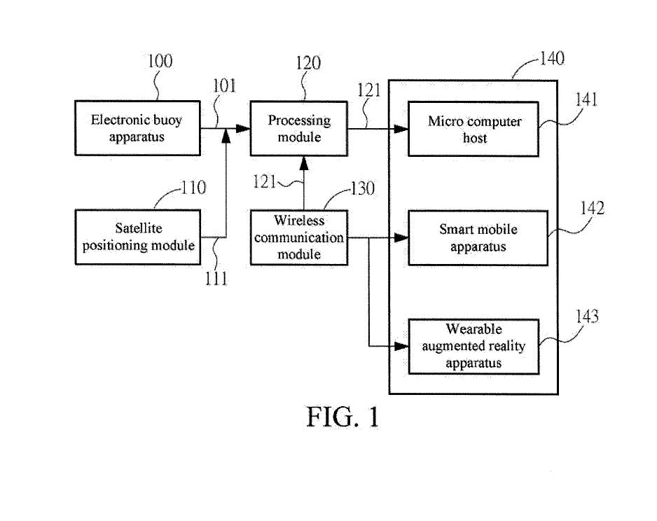

Referring to FIG. 1 to FIG. 3, FIG. 1 is a schematic block diagram of an electronic buoy radar chart display system according to an embodiment of the present invention. An electronic buoy radar chart display system of the present invention is applicable to a ship, and includes: an electronic buoy device 100, a satellite positioning module 110, a processing module 120, wireless communication module 130 and a radar chart display apparatus 140.

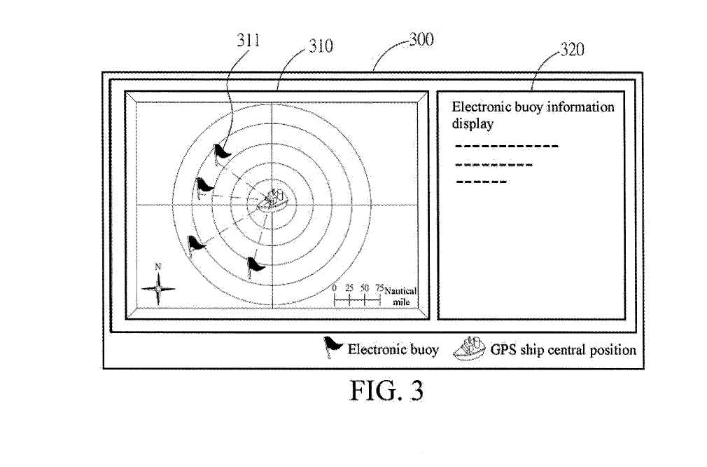

FIG. 3 is a schematic diagram of a radar chart operation interface according to an embodiment of the present invention, and the radar chart display apparatus 140 includes: a radar chart operation interface 300, a graphic information display region 310, an electronic buoy icon 311, and an electronic buoy information display region 320.

The electronic buoy apparatus 100 may include an electronic buoy and a buoy transceiver, the electronic buoy is disposed at a fishing net or a fishing site of fishes in the sea and therefore includes a plurality of electronic buoys, and the electronic buoy transmits electronic buoy positioning data to the buoy transceiver; and the satellite positioning module 110 is configured to acquire positioning data of the ship.

The processing module 120 acquires electronic buoy positioning data 101 from the buoy transceiver of the electronic buoy apparatus 100, acquires ship positioning data 111 from the satellite positioning module 110, conducts analytic operation on the electronic buoy positioning data 101 and the ship positioning data 111 to calculate relative position data 121, that is, the relative position data 121 of the electronic buoy relative to the ship, including information such as a relative position, a distance, an angle and an orientation.

As described above, the calculation of a relative distance D1 is defined by: the electronic buoy positioning data 101 is a coordinate (Xbuoy, Ybuoy), the ship positioning data 111 is a coordinate (Xship, Yship), and the relative distance D1 will be 2R arcsin [sin²(Yₛₕᵢₚ−Y_{buoy}/2)+cos(Y_{buoy})cos(Yₛₕᵢₚ)sin²(Xₛₕᵢₚ−X_{buoy}/2)]^{1/2}, wherein R is the radius of the sphere, in the embodiments, the sphere is Earth, X_{buoy} is the longitude of buoy, Y_{buoy} is the latitude of buoy, Xₛₕᵢₚ is the longitude of the ship, and Yₛₕᵢₚ is the latitude of the ship.

By the above, the relative distance D1 can be scaled up to obtain an actual relative distance D2, for example, when the unit of the relative distance D1 is in “degree”, and the relative distance D1 is scaled up by 60-times so as to obtained the actual relative distance D2 (nautical miles).

The radar chart display apparatus 140 acquires the electronic buoy positioning data 101, the ship positioning data 111 and the relative position data 121 from the processing module 120, and displays them on the radar chart operation interface 300, the radar chart operation interface 300 displays a plurality of electronic buoy representative icons 311 corresponding to the electronic buoy positioning data 101, and after one of the electronic buoy representative icons 311 is selected, the radar chart operation interface 300 will display relative position data of a position represented by the electronic buoy representative icon 311 and the ship.

The processing module 120 receives the electronic buoy positioning data 101 and the ship positioning data 111 at intervals, and updates the electronic buoy positioning data, the ship positioning data and the relative position data, thereby achieving an automatic update function.

The radar chart display apparatus of the present invention may be a computer host 141, may also be a smart mobile apparatus 142 or a wearable augmented reality apparatus 143 that has a necessary radar chart application program installed therein, or another apparatus that can display the radar chart operation interface 300; if it is a wireless apparatus, the electronic buoy positioning data, the ship positioning data and the relative position data are acquired indirectly from the processing module 120 by using the wireless communication module 130.

In this embodiment, the ship sails in the sea or even conducts offshore works, so the wireless communication module 130 does not need to depend on base stations to implement communication tasks, and a most preferable implementation is a wireless communication module implemented based on a peer-to-peer wireless communication protocol, such as a Bluetooth module, a ZigBee module, a Wi-Fi module supporting the Wi-Fi Direct technique, or other related wireless communication modules.

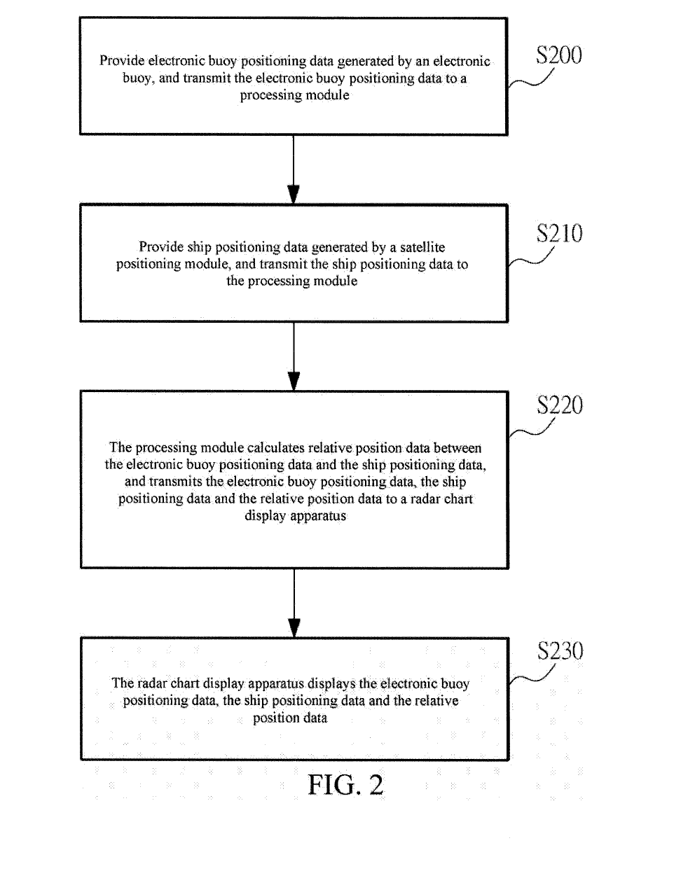

Referring to FIG. 2 together with FIG. 1 and FIG. 3, FIG. 2 is a flow chart of steps of an electronic buoy radar chart display method according to an embodiment of the present invention, and the method includes the following steps.

First, in step S200, electronic buoy positioning data 101 generated by an electronic buoy apparatus 100 is provided, and the electronic buoy positioning data 101 is transmitted to a processing module 120, where the electronic buoy apparatus 100 may include an electronic buoy and a buoy transceiver, and the electronic buoy is disposed at a fishing net or a fishing site of fishes in the sea and therefore includes a plurality of electronic buoys.

Then, in step S210, ship positioning data 111 generated by a satellite positioning module 110 is provided, and the ship positioning data 111 is transmitted to the processing module 120.

Then, in step S230, the processing module 120 calculates relative position data 121 between the electronic buoy positioning data 101 and the ship positioning data 111, and transmits the electronic buoy positioning data, the ship positioning data and the relative position data to a radar chart display apparatus 140, in other words, the processing module 120 analyzes the electronic buoy positioning data and the ship positioning data and then performs operation to obtain relative position information 121 of the electronic buoy relative to the ship, and the relative position information includes information such as a relative position, a distance, an angle, and an orientation.

The processing module 120 receives the electronic buoy positioning data 101 and the ship positioning data 111 at intervals, and updates the electronic buoy positioning data 101, the ship positioning data 111 and the relative position data 121, thereby achieving an automatic update function.

Finally, in step S240, the radar chart display apparatus 140 displays the electronic buoy positioning data 101, the ship positioning data 111 and the relative position data 121. In other words, the processing module 120 transmits the electronic buoy positioning data, the ship positioning data and the relative position data of the electronic buoy relative to the ship to a radar chart operation interface 300 of the radar chart display apparatus 140, and an icon representing the electronic buoy is displayed on the radar chart operation interface 300. Further, another operation manner may be performed directed to the radar chart display apparatus 140, for example, after one electronic buoy icon 311 is designated, corresponding relative position information between the electronic buoy and the ship will be displayed on the radar chart operation interface 300, and may be updated automatically.

In this embodiment, the radar chart operation interface 300 is mainly divided into two block types: a graphic information display region 310 and an electronic buoy information display region 320, where the electronic buoy information display region 320 is configured to display content such as text, small icons and function buttons, so as to assist the graphic information display region 310 to perform further interpretation and operation on information.

In this embodiment, the radar chart display apparatus may be implemented as an apparatus that displays the radar chart operation interface 300 through a touch screen, for example: a smart mobile apparatus, and a computer apparatus such as a computer, a notebook computer or a desktop computer, in which a display scale of the graphic information display region 310 is zoomed in or out by using a finger sliding operation, voice, or by clicking a zoom function button on the touch screen, so as to obtain a broader electronic buoy monitoring region range, and an electronic buoy icon in the graphic information display region 310 is designated by touching with a finger or by using voice, so as to display more detailed information in the electronic buoy information display region 320.

In this embodiment, the radar chart display apparatus may be implemented as a wearable augmented reality apparatus, such as: smart glasses, a head-mounted display apparatus, or an ear-hook display apparatus, which displays a picture overlapping the radar chart operation interface 300 and a real world scene, and zooms a display scale of the graphic information display region 310 and designates an electronic buoy icon of the graphic information display region 310 by using a gesture detection function or a voice identification function, so as to display more detailed information in the electronic buoy information display region 320.

In this embodiment, the radar chart display apparatus may be implemented as a projection touch apparatus, for example, a smart watch, a smart phone, a tablet computer or a projector having a touch detection function, which presents the radar chart operation interface 300 by using a projection unit and the projection technique, detects a touch operation behavior by using a distance sensor or by using a camera in combination with the image identification technique, and then achieves the functions of zooming a display scale of the graphic information display region 310 and designating an electronic buoy icon of the graphic information display region 310 by using touch operations.

In this embodiment, the radar chart display apparatus may be implemented as a radar chart display apparatus having a cursor operation function. The radar chart display apparatus having a cursor operation function can operate a radar chart display interface thereof through a cursor, and an operation manner includes controlling the cursor to click a zoom function button in the electronic buoy information display region 320, so as to zoom a display scale of the graphic information display region 310, to obtain a broader electronic buoy monitoring region range, and includes designating an electronic buoy icon of the graphic information display region 310 by selecting or clicking through the cursor, so as to display more detailed information in the electronic buoy information display region 320. For the radar chart display apparatus having a cursor operation function, a source of a cursor control signal thereof includes: a mouse, a keyboard, a joystick, or the cursor control signal is generated by using a camera thereof in combination with an iris recognition technique used to detect movement of a pupil, or the cursor control signal is generated by receiving a brain wave by using a brain-machine interface module disposed therein.

In the present invention, using a smart mobile apparatus, a computer or a wearable augmented reality apparatus as the electronic buoy display apparatus is advantageous in that: 1. Expansive hardware construction cost that needs to be paid for a conventional system integrating an electronic buoy application may be reduced; 2. The apparatus is portable, which increases flexibility in use, and accordingly improves the reaction capability of ship personnel on work situations; 3. Subsequently, without changing the existing system architecture, version upgrade may be performed for the radar chart application program, so as to obtain more friendly operation interface and process, integrate a sensor function of the mobile apparatus, and connect to the Internet for cloud services; in such way, advancements of future science and technology can be enjoyed without spending high cost.

In view of the above, the present invention discloses how to construct a more intuitive and more friendly operation and display process in a case of acquiring electronic buoy information around a ship, so as to provide better fishing work flexibility and better interaction capability with the environment for ship personnel, which is conducive to improving the efficiency of fishing works, and further reducing the fuel consumption cost wasted for invalid sailing.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An electronic buoy radar chart display system, applicable to a ship, comprising:
an electronic buoy apparatus, configured to generate electronic buoy positioning data according to a position where an electronic buoy locates, and transmit the electronic buoy positioning data to a buoy transceiver;
a satellite positioning module, configured to generate ship positioning data corresponding to the ship position;
a processing module, connected to the buoy transceiver and the satellite positioning module, and configured to receive the electronic buoy positioning data and the ship positioning data, and calculate relative position data according to the electronic buoy positioning data and the ship positioning data; and
a radar chart display apparatus, configured to display the electronic buoy positioning data, the ship positioning data, and the relative position data.

2. The electronic buoy radar chart display system according to claim 1, wherein the processing module receives the electronic buoy positioning data and the ship positioning data at intervals, and updates the electronic buoy positioning data, the ship positioning data and the relative position data.

3. The electronic buoy radar chart display system according to claim 1, wherein the electronic buoy positioning data is a coordinate (X_{buoy}, Y_{buoy}), the ship positioning data is a coordinate (Xₛₕᵢₚ, Yₛₕᵢₚ), and the relative distance is 2R arcsin [sin²(Yₛₕᵢₚ−Y_{buoy}/2)+cos(Y_{buoy})cos(Yₛₕᵢₚ)sin²(Xₛₕᵢₚ−X_{buoy}/2)]^{1/2}, wherein R is the radius of the sphere, X_{buoy} is the longitude of buoy, Y_{buoy} is the latitude of buoy, Xₛₕᵢₚ is the longitude of the ship, and Yₛₕᵢₚ is the latitude of the ship.

4. The electronic buoy radar chart display system according to claim 1, wherein the radar chart display apparatus is a smart mobile apparatus, and the smart mobile apparatus receives the electronic buoy positioning data, the ship positioning data and the relative position data in the processing module by using a wireless communication module.

5. The electronic buoy radar chart display system according to claim 1, wherein the radar chart display apparatus is a wearable augmented reality apparatus, and the wearable augmented reality apparatus receives the electronic buoy positioning data, the ship positioning data and the relative position data in the processing module by using a wireless communication module.

6. An electronic buoy radar chart display method, comprising:
providing electronic buoy positioning data generated by an electronic buoy, and transmitting the electronic buoy positioning data to a processing module;
providing ship positioning data generated by a satellite positioning module, and transmitting the ship positioning data to the processing module;
calculating, by the processing module, relative position data between the electronic buoy positioning data and the ship positioning data, and transmitting the electronic buoy positioning data, the ship positioning data and the relative position data to a radar chart display apparatus; and
displaying, by the radar chart display apparatus, the electronic buoy positioning data, the ship positioning data and the relative position data.

7. The electronic buoy radar chart display method according to claim 6, wherein the processing module receives the electronic buoy positioning data and the ship positioning data at intervals, and updates the electronic buoy positioning data, the ship positioning data and the relative position data.

8. The electronic buoy radar chart display method according to claim 6, wherein the electronic buoy positioning data is a coordinate (X_{buoy}, Y_{buoy}), the ship positioning data is a coordinate (Xₛₕᵢₚ, Yₛₕᵢₚ), and the relative distance is 2R arcsin [sin²(Yₛₕᵢₚ−Y_{buoy}/2)+cos(Y_{buoy})cos(Yₛₕᵢₚ)sin²(Xₛₕᵢₚ−X_{buoy}/2)]^{1/2}, wherein R is the radius of the sphere, X_{buoy} is the longitude of buoy, Y_{buoy} is the latitude of buoy, Xₛₕᵢₚ is the longitude of the ship, and Yₛₕᵢₚ is the latitude of the ship.

9. The electronic buoy radar chart display method according to claim 6, wherein the radar chart display apparatus is a smart mobile apparatus, and the smart mobile apparatus receives the electronic buoy positioning data, the ship positioning data and the relative position data in the processing module by using a wireless communication module.

10. The electronic buoy radar chart display method according to claim 6, wherein the radar chart display apparatus is a wearable augmented reality apparatus, and the wearable augmented reality apparatus receives the electronic buoy positioning data, the ship positioning data and the relative position data in the processing module by using a wireless communication module.
